(19) United States
(12) Patent Application Publication
(10) Pub. No.: US 2021/0106944 A1
(43) Pub. Date: Apr. 15, 2021

(54) ABSORBENT COMPOSITIONS INCLUDING AMINO-SILOXANES

(71) Applicant: GE Oil & Gas, Inc., Houston, TX (US)

(72) Inventor: Robert James PERRY, Niskayuna, NY (US)

(21) Appl. No.: 16/603,292

(22) PCT Filed: Apr. 12, 2017
(86) PCT No.: PCT/US2017/027087

§ 371 Date: Oct. 7, 2019

(51) Int. Cl. B01D 53/14; C08G 77/28; C08G 77/04; C07F 7/08

(52) U.S. Cl. CPC B01D 53/1493; B01D 53/1475; C08G 77/28; C08G 77/045; B01D 2252/20405; B01D 2252/2041; B01D 2252/20415; B01D 2252/20426; C07F 7/0838

(57) ABSTRACT

An absorbent composition including an amino-siloxane is presented. The amino-siloxane includes structure (I): wherein R¹ is independently at each occurrence a C₁-C₆ aliphatic or aromatic radical; R² is independently at each occurrence a C₂-C₁₀ aliphatic or aromatic radical; and R³ is independently at each occurrence a C₁-C₁₈ aliphatic or aromatic radical or R^{4′} wherein R⁴ comprises structure (II): wherein X is independently at each occurrence an electron donating group; and n is at least 1. Methods of reducing an amount of carbon dioxide in a process stream using the absorbent composition are also presented.

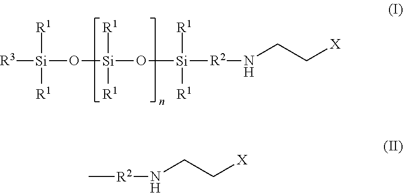

### BACKGROUND

Power generating processes that are based on combustion of carbon-containing fuel typically produce carbon dioxide (CO₂) and other exhaust gases as byproducts. The exhaust gases may be harmful to the environment, such as by contributing to the greenhouse effect and global warming. It may be desirable to capture or otherwise separate the CO₂ from the gas stream exhausted to the environment to reduce the CO₂ emissions and/or to utilize CO₂ in the power generation process or in other processes.

Conventional absorbent solvents used to capture a target gas, such as CO₂ or other exhaust gases, experience increased viscosity when exposed to the target gas. The increased viscosity of the solvent has several disadvantages. For example, the absorbent solvents may form solids or very high viscosity oils upon reacting with CO₂. The increased viscosity reduces the mass transfer of CO₂ into the solvent, such that the absorbent solvent reacts with less CO₂ than is theoretically possible. Furthermore, materials that form solid CO₂ reaction products may not readily fit into existing CO₂ capture process schemes which are designed for flowable liquids.

In order to avoid the issues associated with the increased viscosity of the absorbent solvent upon reaction, some conventional absorbent solvents dilute the concentration of the absorbent composition in the solvent using a carrier fluid, such as water. Although using a carrier fluid can reduce the viscosity of the reaction product, the reduced concentration of the absorbent composition also reduces the performance of the absorbent solvent by decreasing the amount of CO₂ that can be absorbed, referred to herein as CO₂-uptake. Moreover, the use of the carrier fluid also increases the energy consumption of the process relative to not using the carrier fluid, due to the energy required for heating and evaporation of the carrier fluid.

### BRIEF DESCRIPTION

In one embodiment, an absorbent composition is provided that includes an amino-siloxane comprising structure (I):

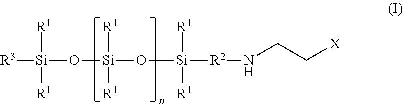

wherein R¹ is independently at each occurrence a C₁-C₆ aliphatic or aromatic radical; R² is independently at each occurrence a C₂-C₁₀ aliphatic or aromatic radical; and R³ is independently at each occurrence a C₁-C₁₈ aliphatic or aromatic radical or R⁴, wherein R⁴ comprises structure (II):

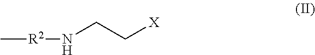

wherein X is independently at each occurrence an electron donating group; and n is at least 1.

In one embodiment, an absorbent composition is provided that includes an amino-siloxane comprising structure (III):

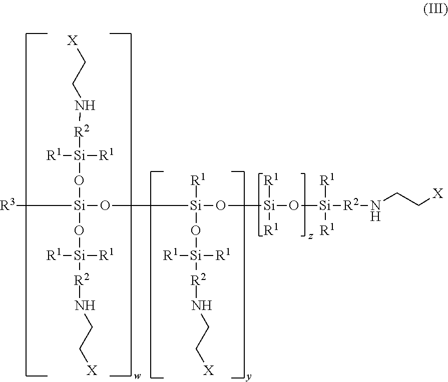

wherein R¹ is independently at each occurrence a C₁-C₆ aliphatic or aromatic radical; R² is independently at each occurrence a C₂-C₁₀ aliphatic or aromatic radical; and R³ is independently at each occurrence a C₁-C₁₈ aliphatic or aromatic radical or R⁴, wherein R⁴ comprises structure (IV):

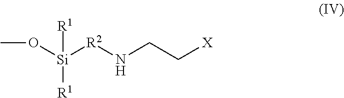

wherein X is independently at each occurrence an electron donating group; w is between 0 and 5; y is between 0 and 10; and z is between 0 and 10; wherein a sum of w, y, and z is at least 1.

In one embodiment, an absorbent composition is provided that includes an amino-siloxane comprising structure (V):

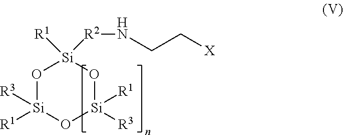

wherein R¹ is independently at each occurrence a C₁-C₆ aliphatic or aromatic radical; R² is independently at each occurrence a C₂-C₁₀ aliphatic or aromatic radical; and R³ is independently at each occurrence a C₁-C₁₈ aliphatic or aromatic radical or R⁴, wherein R⁴ comprises structure (II):

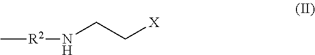

wherein X is independently at each occurrence an electron donating group; and n is between 1 and 6.

### BRIEF DESCRIPTION OF THE DRAWINGS

FIG. 1 shows a table of data relating to five different comparative example absorbent compositions that include different amino-siloxane structures.

FIGS. 2A and 2B show a table of data relating to five different working example absorbent compositions that include different amino-siloxane structures according to an embodiment.

FIG. 3 shows a table of data relating to four working example absorbent compositions that include amino-siloxane structures having different functional groups according to an embodiment.

### DETAILED DESCRIPTION

One or more embodiments of the inventive subject matter described herein provide absorbent compositions, which are also referred to as absorbent solvents. The absorbent compositions include amino-siloxanes. Also described are methods of using these absorbent compositions as gas absorbents to capture target gases, such as CO₂, from process gas streams. More particularly, the absorbent compositions described herein are configured to form a reaction product with the target gas, such that the reaction product remains in a substantially liquid (e.g., flowable) state during and after the target gas capture process, while satisfying target gas uptake performance standards or goals.

The amino-siloxanes in the absorbent compositions described herein have various different core architectures or structures, including extended linear chain core structures, branched core structures, and cyclic core structures. The different amino-siloxanes were synthesized to contain various electron-donating amine functional arms branching from the core structures. The electron-donating amine functional arms are configured to react with and bond to the target gas molecules to capture the target gas from the process stream. In one or more embodiments, the electron-donating amine functional arms include aliphatic amino branches with secondary amines. For example, one or more functional groups may be an ethoxyethylaminopropyl group extending from the core structure.

As described herein, the absorbent compositions were experimentally tested to analyze the CO₂ uptake of the compositions and the physical states of the reaction products. The results indicate that the absorbent compositions described herein displayed at least satisfactory CO₂ uptake and maintained a substantially liquid, flowable state after reaction.

As used herein, an element or step recited in the singular and proceeded with the word “a” or “an” should be understood as not excluding plural of said elements or steps, unless such exclusion is explicitly stated. Furthermore, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

Approximating language, as used herein, may be applied to modify any quantitative representation that could permissibly vary without resulting in a change in the basic function to which it is related. Accordingly, a value modified by a term such as “about” or “substantially” is not limited to the precise value specified. In some instances, the approximating language may correspond to the precision of an instrument for measuring the value.

As used herein, the term “aliphatic radical” refers to an organic radical having a valence of at least one consisting of a linear or branched array of carbon and hydrogen atoms, which is not cyclic. The aliphatic radicals include fully saturated hydrocarbon molecules (e.g., alkanes) and unsaturated hydrocarbon molecules (e.g., alkenes or alkynes). By way of example, a C₁-C₅ aliphatic radical contains at least one but no more than five carbon atoms. For example, a methyl group (i.e., CH₃—) is a C₁ aliphatic radical, an ethyl group (i.e., CH₃CH₂—) is a C₂ aliphatic radical, a propyl group (i.e., CH₃(CH₂)₂—) is a C₃ aliphatic radical, and a butyl group (i.e., CH₃(CH₂)₃—) is a C₄ aliphatic radical. As used herein, the term “aromatic radical” refers to a cyclic hydrocarbon molecule with at least one double bond. For example, phenyl is a C₆ aromatic molecule. As used herein, a “heterocyclic” compound or group refers to a cyclic compound that has atoms of at least two different elements as members of the ring or rings of the compound. For example, piperidine and pyridine are two examples of heterocyclic compounds.

The term “electron donating group” as used herein refers to a group of atoms that releases electrons into a reaction center and stabilizes electron deficient carbocations. Non-limiting examples of suitable electron donating groups include alkoxy groups, hydroxyl groups, sulfide groups, phosphino groups, and amine groups. More specifically, the electron donating groups in some amino-siloxanes described herein may include an R³O— group, an R³S— group, an (R³)₂N— group, or an (R³)₂P— group; where R³ is a C₁-C₅ aliphatic radical.

In one embodiment, an absorbent composition is provided that includes an amino-siloxane that has an extended linear chain core structure. For example, the amino-siloxane includes structure (I):

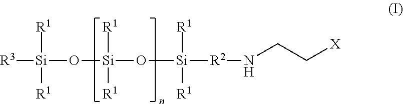

wherein R¹ is independently at each occurrence a C₁-C₆ aliphatic or aromatic radical; R² is independently at each occurrence a C₂-C₁₀ aliphatic or aromatic radical; and R³ is independently at each occurrence a C₁-C₁₈ aliphatic or aromatic radical or R⁴, wherein R⁴ comprises structure (II):

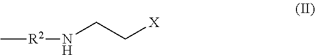

wherein X is independently at each occurrence an electron donating group; and n is at least 1. When R³ is other than R⁴, the amino-siloxane has a single amine functional arm branching from the core structure. When R³ is the structure (II) of R⁴, the amino-siloxane is difunctional due to the two amine functional arms branching from the core structure. The two amine functional arms may be identical to one another, but alternatively may differ from one another. For example, the amine functional arms may have different electron donating groups at the distal ends thereof. The siloxane core structure includes a linear chain of siloxy units (shown in brackets to denote a repeating unit). The siloxane core structure includes at least one siloxy repeat unit. For example, some embodiments may include between two and ten siloxy repeat units. The length of the extended linear core structure is proportional to the number of siloxy repeat units, such that a greater number of siloxy repeat units indicates a longer linear core structure. In one embodiment, the siloxy repeat unit is a dimethylsiloxy unit, such that the R¹ groups in the repeat unit represent methyl groups.

In another embodiment, the amino-siloxane of the absorbent composition has an amino-siloxane that includes structure (III):

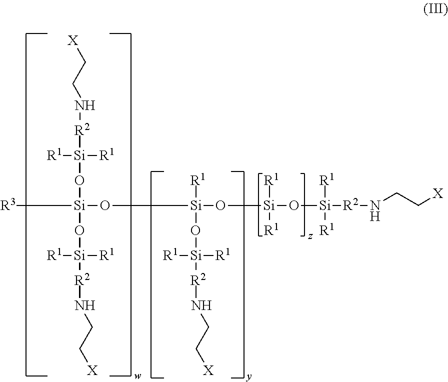

wherein R¹ is independently at each occurrence a C₁-C₆ aliphatic or aromatic radical; R² is independently at each occurrence a C₂-C₁₀ aliphatic or aromatic radical; and R³ is independently at each occurrence a C₁-C₁₈ aliphatic or aromatic radical or R⁴, wherein R⁴ comprises structure (IV):

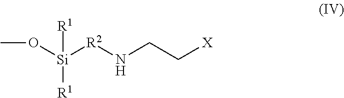

wherein X is independently at each occurrence an electron donating group; w is between 0 and 5; y is between 0 and 10; and z is between 0 and 10; wherein a sum of w, y, and z is at least 1.

The amino-siloxane in structure (III) can include an extended linear core structure and/or a branched core structure. The amino-siloxane includes a double-branching repeat unit at w, a single-branching repeat unit at y, and a siloxy repeat unit (that lacks functional groups) at z. The amino-siloxane includes at least one of the repeat units because the sum of w, y, and z is at least 1. It is recognized that the amino-siloxane of structure (III) can have both a branched core structure (e.g., w and/or y is at least 1) and an extended linear core structure (e.g., z is at least 1). For example, if w and y are both 0, and z is at least 1, then the amino-siloxane has an extended linear core structure (without branching). In another example, if w or y is at least 1, then the amino-siloxane has a branched core structure. For example, if w is 1 and y is 0, then the amino-siloxane can be tri-functional or tetra-functional, depending on whether or not R³ comprises structure (IV) of R⁴. When R³ comprises structure (IV) (and w is 1 and y is 0), the amino-siloxane is tetra-functional, with four amine functional arms branching from the core structure. The siloxane core structure may be star-shaped or diamond-shaped, such that a central silicon atom is bonded to four siloxane branches. When R³ is an aliphatic or aromatic radical, such as a phenyl group, the amino-siloxane is tri-functional. The multiple siloxane branches may be identical to one another, but alternatively may differ from one another. For example, one or more of the siloxane branches may include different electron donating groups at the distal ends of the branches. When w is 0 and y is 1, then the amino-siloxane can be difunctional or tri-functional, depending on whether or not R³ comprises structure (IV) of R⁴. When R³ comprises structure (IV), the amino-siloxane is tri-functional, with three amine functional arms branching from the core structure. The amino-siloxane is difunctional when R³ is either an aliphatic radical or an aromatic radical, such as a phenyl group.

In yet another embodiment, the amino-siloxane of the absorbent composition has a cyclic core structure. For example, the amino-siloxane includes structure (V):

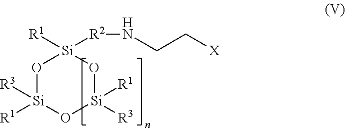

wherein R¹ is independently at each occurrence a C₁-C₆ aliphatic or aromatic radical; R² is independently at each occurrence a C₂-C₁₀ aliphatic or aromatic radical; and R³ is independently at each occurrence a C₁-C₁₈ aliphatic or aromatic radical or R⁴, wherein R⁴ comprises structure (II):

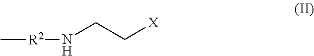

wherein X is independently at each occurrence an electron donating group; and n is between 1 and 6. The amino-siloxane can include from 1 to 6 of the silicon and oxygen pair repeat units (denoted by the brackets). Since the core also includes two other pairs of silicon atoms and oxygen atoms outside of the brackets, the ring-shaped core can have between three and eight alternating pairs of silicon and oxygen atoms (e.g., for a total of between six and sixteen atoms in the ring). Although only one amine functional arm is shown in structure (V), it is noted that each R³ can be the structure (II) of R⁴. When n is 6 (e.g., that the core has eight silicon atoms), the amino-siloxane can include up to eight amine functional arms extending from the cyclic core if each R³ is the structure (II) of R⁴. The details and various alternatives of the amine functional arms of the structure (V) are the same as the amine functional arms of the structure (I) described above.

The absorbent compositions described herein include amino-siloxanes having structures (I), (III), or (V). The absorbent compositions are solvents that are liquid under reaction conditions. The absorbent compositions are configured to react with a target gas, such as CO₂, to form a reaction product, which is referred to herein as an adduct. More specifically, the adduct of a secondary amine functional group with CO₂ is a carbamate. The absorbent compositions described herein are useful for capturing CO₂ because the adduct remains in a substantially flowable, liquid phase under reaction conditions following exposure to CO₂. The term “substantially liquid” as used herein means that the amino-siloxane and the adduct are characterized by a melting temperature or a glass transition temperature lower than the temperature at which the amino-siloxane absorbs the CO₂. The reaction conditions may include a temperature range between about 10 degrees Celsius (C) and about 70 degrees C. Typically, the temperature range under reaction conditions is between about 20 degrees C. and about 50 degrees C. The pressure range under reaction conditions may be between about 97 kPa and about 105 kPa.

The absorbent composition optionally may include one or more other components in addition to the amino-siloxane. For example, the absorbent composition may have an oxidation inhibitor or antioxidant (e.g., to increase the oxidative stability), a corrosion inhibitor, an anti-foaming agent, or the like.

In one or more embodiments, the amino-siloxane-containing absorbent composition may be substantially free of a carrier fluid, such as water. The term “substantially free” as used in this context means that the absorbent composition contains less than about fifteen volume percent of carrier fluid, such as less than five volume percent of carrier fluid. Optional carrier fluids include water, ionic liquids, glycols, and combinations thereof. Therefore, even in embodiments in which the absorbent composition includes a carrier fluid, the concentration of the carrier fluid in the composition is sufficiently low (e.g., less than fifteen volume percent) to not adversely affect the absorption process. For example, the carrier fluid does not have a significant effect on the CO₂ uptake (or absorption capability) of the absorbent composition, and does not require significant energy to heat and/or evaporate the carrier fluid.

The amino-siloxane absorbent compositions described herein may not require the use of additional solvents, such as carrier fluids, in order to achieve an acceptable viscosity level. Further, the amino-siloxane compositions have low volatility, high thermal stability, and a high net capacity for CO₂. The amino-siloxane compositions can be appropriate for large-scale implementation. For these reasons, the amino-siloxane compositions provided herein may perform better than conventional absorbent solvents utilized for absorbing CO₂ from process gas streams.

In an embodiment, a method of reducing an amount of CO₂ in a process stream is presented that includes contacting the process stream with an absorbent composition that includes an amino-siloxane having structure (I), (III), or (V), as described herein. The process stream is typically gaseous but may contain solid or liquid components. The process stream may be at a wide range of temperatures and pressures, depending on the application. For example, the process stream may be exposed to the absorbent composition at a temperature between about 10 degrees C. and 70 degrees C. The process stream may be a process stream from a manufacturing process within a power plant (e.g., coal, natural gas, or the like), a factory, a manufacturing plant, or the like. The manufacturing process may be associated with a chemical industry, a cement industry, a steel industry, or the like. The process stream may be generated from a combustion process, a gasification process, a landfill, a furnace, a steam generator, a gas turbine, a boiler, or the like. For example, the process stream may be a flue gas including a gas mixture exhausted as a result of the processing of fuels, such as natural gas, biomass, gasoline, diesel fuel, coal, oil shale, fuel oil, tar sands, or combinations thereof. The method may be useful in power plants requiring absorbents for reducing CO₂ emissions. In another embodiment, the process stream includes syngas generated by gasification at a reforming plant.

The step of contacting the process stream with the amino-siloxane absorbent composition optionally may be effected under controlled conditions (e.g., temperature, pressure, humidity, etc.) in a reaction chamber. Non-limiting examples of suitable reaction chambers may include an absorption tower, a wetted wall tower, a spray tower, a venturi scrubber, or combinations thereof. Upon contacting the process stream with the absorbent composition, an adduct stream is formed, as well as a CO₂-lean gas stream. The CO₂-lean gas stream has a CO₂ content lower than that of the process stream. The adduct stream may be further subjected to one or more desorption steps to release CO₂ and regenerate the absorbent composition. The CO₂-lean gas stream may be transported to another vessel or system for subsequent processing, may be transported to another vessel or system for storage, or may be released into the environment.

In one embodiment, the method of reducing the amount of carbon dioxide in a process stream includes the step of contacting the process stream with an absorbent composition containing an amino-siloxane having structure (I):

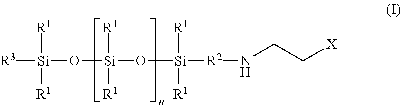

wherein IV is independently at each occurrence a C₁-C₆ aliphatic or aromatic radical; R² is independently at each occurrence a C₂-C₁₀ aliphatic or aromatic radical; and R³ is independently at each occurrence a C₁-C₁₈ aliphatic or aromatic radical or R⁴, wherein R⁴ comprises structure (II):

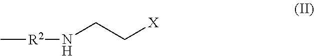

wherein X is independently at each occurrence an electron donating group; and n is at least 1. Optionally, the electron donating group at each occurrence is an R⁵O— group, an R⁵S— group, an (R⁵)₂N— group, or an (R⁵)₂P— group, wherein R⁵ is independently at each occurrence a C₁-C₈ aliphatic or aromatic radical. In other embodiments, the method of reducing the amount of carbon dioxide in a process stream includes the step of contacting the process stream with an absorbent composition containing an amino-siloxane having structure (III) or the structure (V), as described herein.

Examples of amino-silicone compounds with disiloxane core structures for use in CO₂ absorbents are provided in U.S. Pat. No. 9,427,698 (“the '698 Patent”), filed 11 Oct. 2013, which is incorporated by reference herein in its entirety. Compared to the disiloxane core structures disclosed in the '698 Patent, the amino-siloxanes described herein have greater molecular weight core structures. For example, the extended linear chain core structures, the branched core structures, and the cyclic core structures of the amino-siloxanes described herein have greater molecular weights than the disiloxane core structures in the '698 Patent. Since molecular weight is generally proportional to viscosity, it was expected that the larger amino-siloxanes disclosed herein would result in highly viscous or solid adducts upon reacting with CO₂. Furthermore, the core structures of the branched and cyclic amino-siloxanes are more hindered or congested than the disiloxane cores disclosed in the '698 Patent, and were expected to block or otherwise negatively interfere with the interaction between the amine functional groups and the CO₂ in the process stream, therefore resulting in reduced CO₂-capture performance relative to the disiloxane core compounds. In summary, the beneficial performance of the amino-silicones disclosed in the '698 Patent, including achieving high CO₂ uptake and maintaining the reaction product in a flowable liquid phase, was believed to be attributable, at least in part, to the disiloxane core. Similar performance benefits were not expected for the amino-siloxanes disclosed herein that have different, larger core structures.

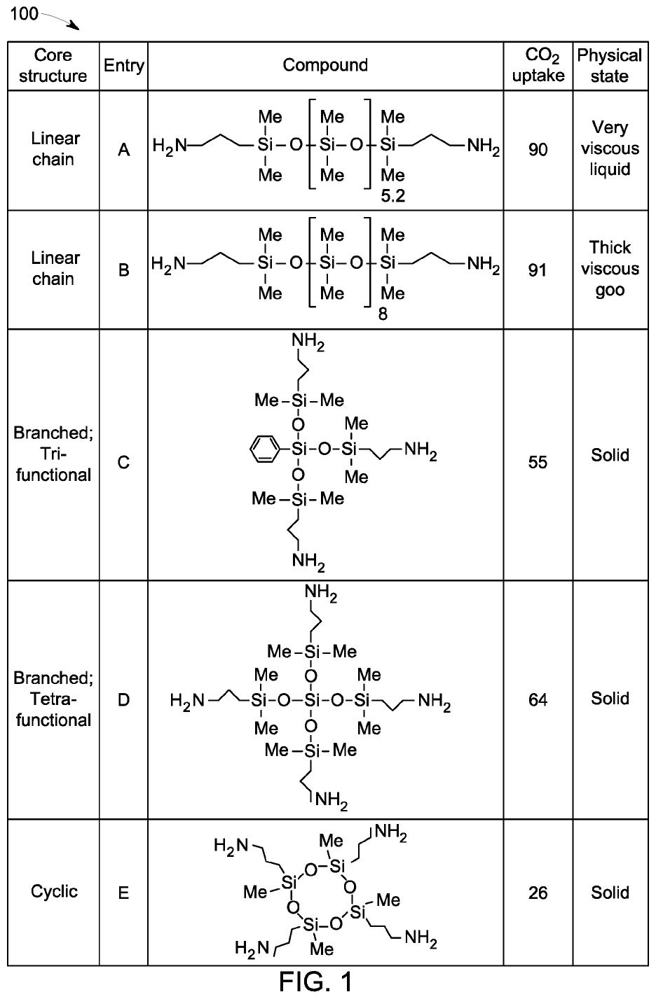

For example, several amino-siloxanes with extended linear chain core structures, branched core structures, and cyclic core structures were prepared and experimentally tested as comparative examples. FIG. 1 shows a table 100 of five different comparative example absorbent compositions. The table 100 includes a Core Structure column that identifies the core structure of the amino-siloxane in each comparative example, an Entry column that provides an identifier for each amino-siloxane, a Compound column that shows the molecular structure of each amino-siloxane, a CO₂ Uptake column that provides a percentage of CO₂ absorbed by each amino-siloxane relative to a calculated theoretical amount of CO₂ that could be absorbed by each amino-siloxane, and a Physical State column that provides a qualitative observation of the phase and/or viscosity of the reaction product or adduct for each amino-siloxane. It is noted that the identifier for each amino-siloxane listed in the Entry column is simply a shorthand reference for the corresponding amino-siloxane without showing the molecular structure or reciting the chemical nomenclature.

As shown in table 100, all five of the comparative example amino-siloxanes have primary amine functional groups extending from the respective core structures. The primary amine functions as the electron-donating group. Furthermore, all of the functional groups of the comparative examples are aminopropyl groups. The top two amino-siloxanes representing entries A and B have extended linear chain core structures and are difunctional. The amino-siloxane A differs from the amino-siloxane B only in the amount of repeating dimethylsiloxy units in the core structure (e.g., 5.2 on average for amino-siloxane A versus 8.0 on average for amino-siloxane B). Therefore, the amino-siloxane B has a longer linear chain core structure than the amino-siloxane A. The third and fourth amino-siloxanes representing entries C and D have branched core structures. The amino-siloxane C is tri-functional and includes a phenyl group bonded to the core structure. The amino-siloxane D is tetra-functional, such that the core structure is star-shaped. The amino-siloxane representing entry E has a cyclic core structure and is also tetra-functional.

The data in the CO₂ Uptake column and Physical State column was obtained experimentally by performing CO₂ uptake testing. The CO₂ uptake testing, used for both the comparative example absorbent compositions shown in table 100 and the working example absorbent compositions described herein, was performed by contacting dry CO₂ gas with a known weight (e.g., a known weight between 0.5 g and 5 g) of the respective absorbent compositions or solvent in a reaction flask. The CO₂ gas was generated via the sublimation of dry ice and passed through a drying tube (e.g., a CaCl₂ drying tube). The mixture was mechanically stirred for a designated time period at a constant temperature. The data shown in the table 100 was measured by reacting the absorbent compositions with the CO₂ gas at a temperature of 40 degrees C., but other uptake testing was performed at different temperatures, such as at a temperature between about 20 degrees C. and about 32 degrees C. In an embodiment, the mixture was mixed at 200 rpm for at least 30 minutes, such as between about 30 minutes and about two hours.

The reaction was considered completed when either a preset elapsed time was reached or a substantially constant weight of the mixture was achieved. For example, the reaction flask with the absorbent composition therein was weighed prior to introducing the CO₂ gas into the reaction flask, and the weight of the reaction flask was monitored during the reaction to measure a weight change of the flask. The weight gain experienced during the reaction was attributable to the CO₂ that reacted with the absorbent composition. The experimental weight gain for each tested absorbent composition was calculated by subtracting the difference between the final and initial weights. The experimental weight gain was compared to a theoretical weight gain to determine a CO₂ uptake percentage. The theoretical weight gain was calculated based on the initial weight and the molecular weight of the candidate absorbent composition. For example, the theoretical weight gain was calculated assuming one mole of CO₂ required two moles of primary or secondary amine for complete reaction. The CO₂ uptake percentage was calculated by dividing the difference between the experimental weight gain and the theoretical weight gain by the theoretical weight gain and then multiplying the result by 100. Additionally, the physical state of the reaction product (or adduct) was observed and reported when the reaction was completed, as shown in the Physical State column.

As shown in table 100, the comparative example absorbent compositions having primary amine functional groups did not perform adequately in the uptake test. Each absorbent composition yielded very viscous liquid or solid adduct. For example, the absorbent compositions having the branched and cyclic amino-siloxanes (e.g., entries C, D, and E) formed solid adducts and also exhibited poor CO₂ uptake percentages in the range of 26% to 64%. Although the absorbent compositions having the extended linear chain core structures (e.g., entries A and B) showed good CO₂ reactivity with 90% or greater absorption, the viscosities of the adducts were excessively high for use in liquid-based processes.

Based on the experimental results concerning amino-siloxane compositions with various core structures (e.g., linear chain, branched, and/or cyclic) and primary amine functional groups, it was expected that substituting the primary amine functional groups with secondary amine functional groups would have little, if any, effect on the CO₂ uptake and viscosities of the adducts.

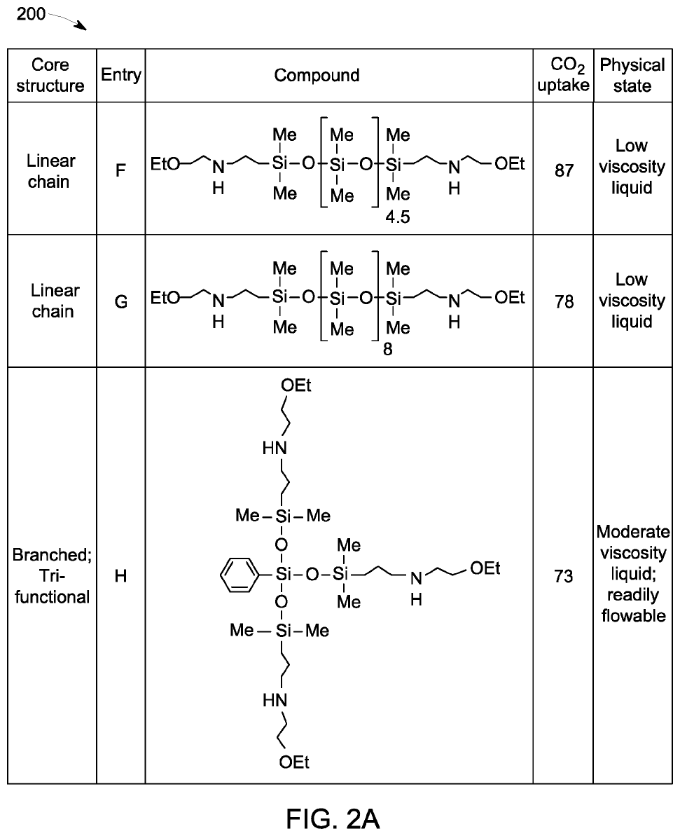

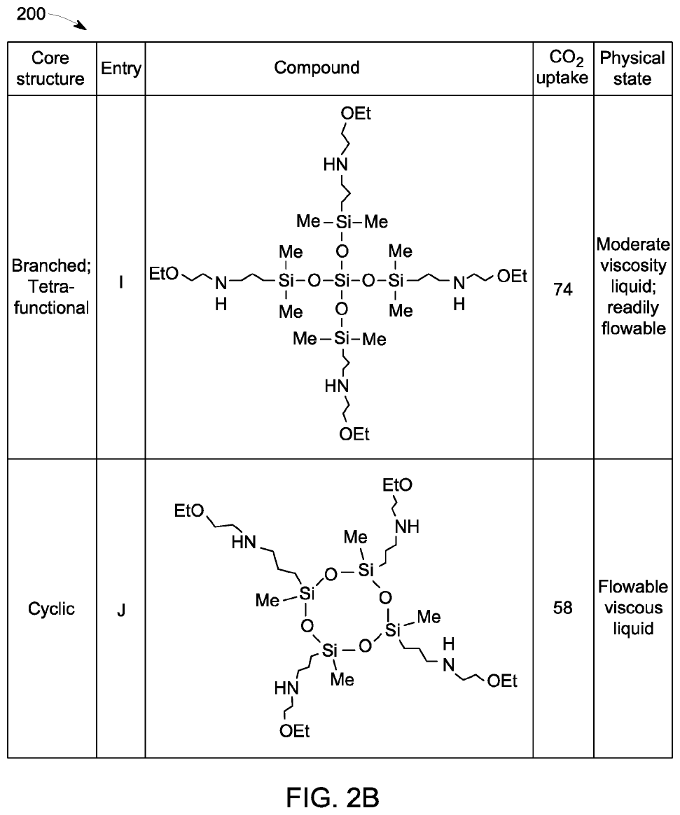

Several amino-siloxanes with extended linear chain core structures, branched core structures, and cyclic core structures were prepared and experimentally tested as working examples. FIGS. 2A and 2B show a table 200 of five different working example absorbent compositions. The table 200 includes the same column headers as the table 100 in FIG. 1.

As shown in table 200, all five of the working example amino-siloxanes have secondary amine functional groups extending from the respective core structures, as opposed to the primary amine functional groups of the comparative example amino-siloxanes. Specifically, all of the functional groups of the working examples include ethoxyethyl groups extending from the secondary amine, which function as electron-donate groups. The data in the CO₂ Uptake column and Physical State column was obtained experimentally by performing CO₂ uptake testing under the same conditions as the CO₂ uptake testing for the comparative examples.

The working examples include two extended linear chain core structures representing entries F and G. The amino-siloxanes F and G are similar to the comparative example amino-siloxanes A and B. The amino-siloxane F differs from the amino-siloxane G only in the amount of repeating dimethylsiloxy units in the core structure (e.g., 4.5 on average for amino-siloxane F versus 8.0 on average for amino-siloxane G). Therefore, the amino-siloxane G has a longer linear chain core structure than the amino-siloxane F. The third amino-siloxane representing entry H has a branched core structure and is tri-functional, similar to the comparative example amino-siloxane C. The fourth amino-siloxane representing entry I has a branched core structure and is tetra-functional, similar to the comparative example amino-siloxane D. The fifth amino-siloxane representing entry J has a cyclic core structure and is also tetra-functional, similar to the comparative example amino-siloxane E.

For example, the amino-siloxane F represents an embodiment of the amino-siloxane having structure (I):

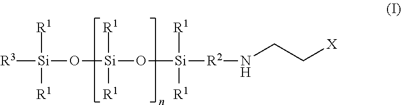

wherein R¹ is a C₁ aliphatic radical (e.g., CH₃—) at each occurrence; R² is a C₃ aliphatic radical at each occurrence; R³ is the structure (II) of R⁴; X is an ethoxy (e.g., C₂H₅O—) electron donating group at each occurrence; and n is 4.5. The amino-siloxane G represents another embodiment of the amino-siloxane having structure (I), which is identical to the amino-siloxane F except that n is 8.0. The amino-siloxane F is also an embodiment of the amino-siloxane having structure (III):

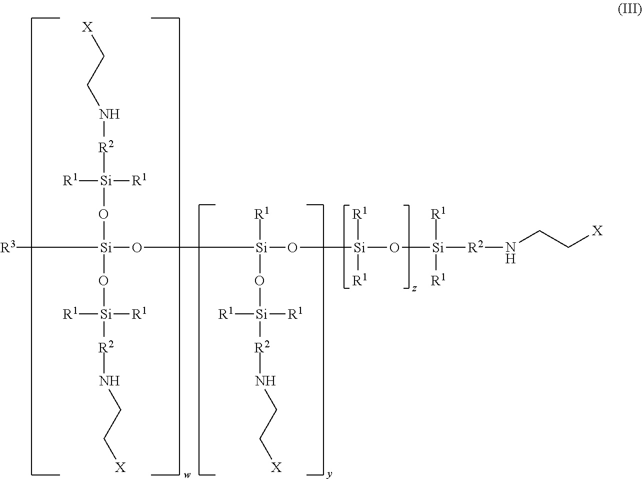

wherein w and y are both 0; R¹ is a C₁ aliphatic radical (e.g., CH₃—) at each occurrence; R² is a C₃ aliphatic radical at each occurrence; R³ is the structure (IV) of R⁴; X is an ethoxy (e.g., C₂H₅O—) electron donating group at each occurrence; and z is 4.5. The amino-siloxane G represents another embodiment of the amino-siloxane having structure (III), which is identical to the amino-siloxane F except that z is 8.0.

The amino-siloxane H represents an embodiment of the amino-siloxane having structure (III):

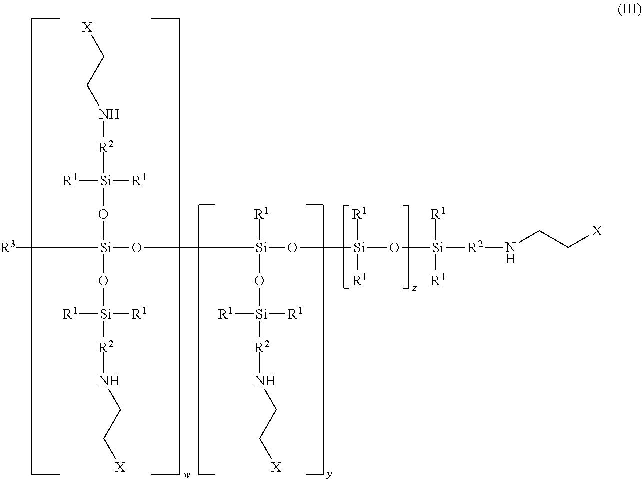

wherein y and z are both 0; R¹ is a C₁ aliphatic radical at each occurrence; R² is a C₃ aliphatic radical at each occurrence, R³ is the aromatic radical phenyl group, and X is an ethoxy group at each occurrence. The amino-siloxane I represents another embodiment of the amino-siloxane having structure (III), which only differs from the amino-siloxane H because R³ is R⁴ and the structure (IV) instead of a phenyl group. The four amine functional arms branching from the start-shaped cored structure in the amino-siloxane I are identical to one another.

The amino-siloxane J represents an embodiment of the amino-siloxane having structure (V):

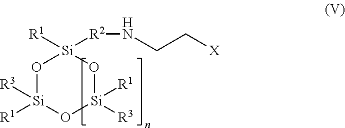

wherein n is 2; IV is a C₁ aliphatic radical at each occurrence; R² is a C₃ aliphatic radical at each occurrence, R3 is the structure (II) of R⁴ at each occurrence; and X is an ethoxy group at each occurrence. As such, the amino-siloxane J is tetra-functional, and all four functional arms branching from the cyclic core are identical to one another. Methods of synthesizing the working example amino-siloxanes are described in more detail herein.

The data in table 200 shows that all five of the working example amino-siloxanes were able to absorb CO₂ and maintain the adduct (e.g., reaction product) in a flowable, liquid phase. The difference in observed viscosities of the adducts between the primary amine-containing compositions of the comparative examples (shown in table 100) and the ethoxyethylamine derivative compositions of the working examples is stark. For example, none of the adducts from the comparative examples is flowable, while all of the adducts from the working examples are flowable, although to different degrees. The adducts of the linear chain amino-siloxanes of entries F and G were low viscosity liquids. The adducts of the branched amino-siloxanes of entries H and I were moderate viscosity liquids that were readily flowable. The adduct of the cyclic amino-siloxane J was a flowable, viscous liquid.

In addition, the table 200 shows that the working example branched and cyclic amino-siloxanes of entries H, I, and J had higher CO₂ uptake percentages than the corresponding comparative example equivalents (e.g., entries C, D, and E). The working example linear chain amino-siloxanes of entries F and G recorded slightly lower CO₂ uptake percentages than the comparative example equivalents (e.g., entries A and B), but the uptake percentages of 87 and 78, respectively, are at a satisfactory level (e.g., above a designated uptake threshold of 70% or the like). Also, the uptake percentages of the entries F and G may be improved by slightly modifying the reaction conditions, as described below in more detail. The tables 100 and 200 show that, by substituting the primary amine functional groups for the secondary amine functional groups (with appropriate heteroatom functionality), amino-siloxanes with large and/or complex core structures may be used for CO₂ capture with beneficial results. For example, since the adducts of the working example amino-siloxanes maintained the liquid phase, the amino-siloxanes can be used in liquid-based processes to reduce the concentration of CO₂ in a process stream.

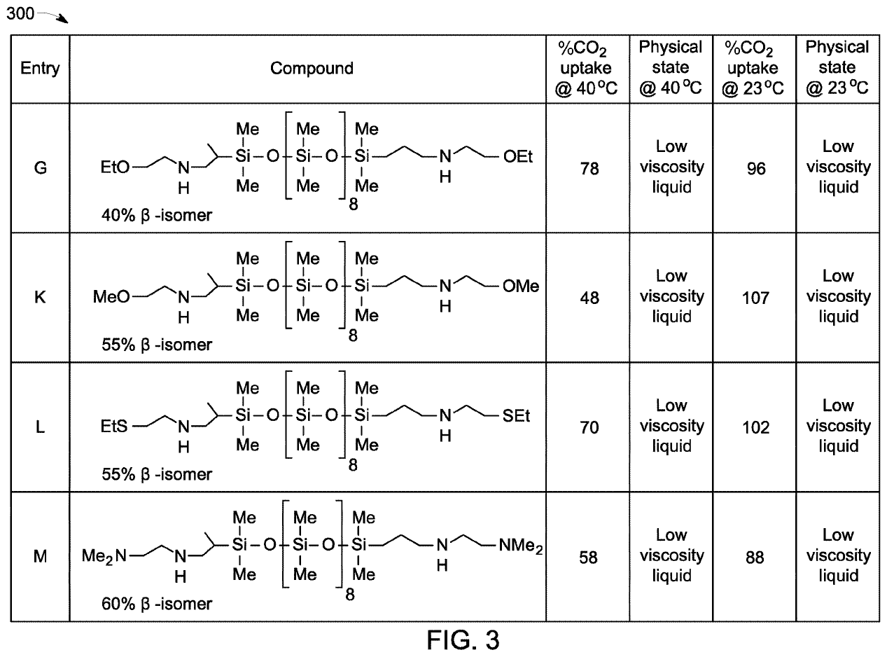

Additional working examples of amino-siloxanes were synthesized to determine the effect, if any, of different secondary amine functional groups on the CO₂ uptake and viscosity of the adduct. For example, FIG. 3 shows a table 300 of four working example absorbent compositions that have different functional groups. All four of the amino-siloxanes in table 300 have the same extended linear chain core structure, but differ in the type of functional group extending from the core structure. The amino-siloxane G is also shown in table 200, and includes an ethoxy (e.g., C₂H₅O—) functional group extending from the secondary amine. The amino-siloxane K includes a methoxy (e.g., CH₃O—) functional group extending from the secondary amine. The amino-siloxane L includes a thioethyl (e.g., C₂H₅S—) functional group extending from the secondary amine. The amino-siloxane M includes a dimethylamino (e.g., (CH₃)₂N—) functional group extending from the secondary amine.

The absorbent compositions including the amino-siloxanes of entries G, K, L, and M were evaluated by performing CO₂ uptake testing at two different temperatures. The CO₂ uptake testing at 40 degrees C. was the same conditions as the CO₂ uptake testing for the working examples shown in table 200 and the comparative examples shown in table 100. As shown in table 300, all four of the amino-siloxanes of entries G, K, L, and M remained as low viscosity liquids after reacting with CO₂. The CO₂ uptake percentages for the entries K, L, and M ranged from 48% to 70%, which lagged behind the CO₂ uptake percentage of the amino-siloxane G having the ethoxy functional group. However, by re-testing the amino-siloxanes at room temperature of 23 degrees C., it was determined that the reaction temperature of 40 degrees C. was the primary cause for the low CO₂ uptake percentages. As shown in the table 300, all of the amino-siloxanes of entries G, K, L, and M achieved high CO₂ uptake percentages of at least 88% of the theoretical when tested at 23 degrees C., and also maintained low viscosity liquid phases in the reaction products. The greater CO₂ uptake percentages for the amino-siloxanes at 23 degree C. versus 40 degrees C. may be attributable to lower heats of reaction for the secondary amine structures at the lower temperature. Based on the experimental results, the working example amino-siloxanes disclosed herein are configured to react with CO₂ within a range of temperatures between about 20 degrees C. and about 40 degrees C. to form reaction products (or adducts) that are substantially liquid. The actual temperature range in which the amino-siloxanes can react with CO₂ to form substantially liquid adducts may be greater than the expressed range, such as having a lower temperature below 20 degrees C. and/or an upper temperature greater than 40 degrees C.

The data in table 300 indicates that the absorbent compositions described herein may have various electron-donating secondary amine functional groups, and are not limited to ethoxy groups. For example, the electron-donating functional groups each may represent an R⁵O— group, an R⁵S— group, an (R⁵)₂N— group, or an (R⁵)₂P— group, wherein R⁵ is a C₁-C₈ aliphatic or aromatic radical. Absorbent compositions including the working example amino-siloxanes with any of the listed functional groups could be used to capture CO₂ from a process stream while maintaining a flowable, liquid phase.

As shown in table 300, the synthesis of the amino-siloxanes of entries G, K, L, and M yielded significant amounts of branched isomers, referred to herein as β-isomers. The β-isomer forms of the amino-siloxanes have a branched isopropyl spacer between the core structure and a secondary amine. The linear isomer form, referred to as γ-isomer, includes a linear propyl spacer between the core structure and the secondary amine for both branches extending from the core structure. Table 300 shows that the percentage of β-isomer compounds for the entries G, K, L, and M ranged from 40% for entry G to 60% for entry M. In order to determine if the presence of the β-isomer affected the CO₂ capture performance, a series of similar amino-siloxanes were synthesized via a different route that did not permit the formation of any β-isomers. Such amino-siloxanes were tested under the same conditions and yielded very similar results as the entries G, K, L, and M. For example, amino-siloxanes lacking β-isomers achieved comparable CO₂ uptake percentages to the entries G, K, L, and M and maintained flowable, liquid phases. Therefore, the presence of the β-isomer had little, if any, impact on CO₂ capture performance.

Although the working example amino-siloxanes described herein (e.g., entries F, G, H, I, J, K, L, and M) all have propyl chain spacers between the core structures and the secondary amines, in one or more embodiments the absorbent compositions may include amino-siloxanes with longer alkyl chain spacers. For example, the alkyl chain spacer may include four or five carbon atoms instead of three. In one embodiment, an amino-siloxane may have the structure (Ia):

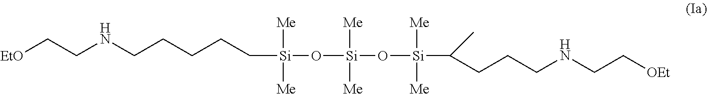 [SMILES: CCOCCNCCCCC[Si](C)(C)O[Si](C)(C)O[Si](C)(C)C(C)CCCNCCOCC]

which is an embodiment of the structure (I), in which n is 1, R¹ is a C₁ aliphatic radical at each occurrence; R² is a C₅ aliphatic radical at each occurrence; R³ is the structure (II) of R⁴; and X is an ethoxy (e.g., C₂H₅O—) electron donating group at each occurrence. The amino-siloxane having structure (Ia) is referred to herein as amino-siloxane N. Amino-siloxane N was synthesized and determined that 10% of the β-isomer was formed. The amino-siloxane N was experimentally tested and determined to yield about 106% of the theoretical uptake with the solvent maintaining a low viscosity profile upon full reaction with CO₂. Therefore, the amino-siloxanes in the CO₂ absorbent compositions disclosed herein may include alkyl chain spacers at R² equal to or longer than propyl spacers.

### Sources and/or Synthesis of Compounds Described Herein

### Compound A

The amino-siloxane A was prepared from the equilibration of bis(1,3-aminopropyl)-1,1,3,3-tetramethyldisiloxane and octamethylcyclotetrasiloxane.

### Compound B

To synthesize the amino-siloxane B, allylamine (1.3 g, 22.8 mmol) was added to hydride capped siloxane (5.02 g, 6.9 mmol, Gelest, DMS-H03) over 2 min with 1 drop of Karstedt's catalyst and heated to 60° C. for 16 h. Volatiles were removed In vacuo to give 5.39 g (93%) product with 25% b-isomer. ¹H NMR (CDCl₃) d: 2.89 (dd, J=12.6, 4.8 Hz, 0.72h); 2.65 (t, J=6.8 Hz, 3.8H); 2.54 (dd, J=12.6 Hz, 0.72H); 1.44 (m, 4H); 1.03 (br 4H); 0.97 (d, J=7.3 Hz, 2H); 0.74 (m, 0.7H); 0.52 (m, 4H); 0.06 (s, 78H). ¹³C {¹H} NMR (CDCl₃): 45.41, 44.27, 27.64, 26.37, 15.20, 11.51, 1.12, 0.99, 0.08 ppm.

### Compound C

To synthesize the amino-siloxane C, a solution of allylamine (2.0 g, 35 mmol) in toluene (5 mL) was added dropwise to a solution of tris(dimethylsiloxy)phenylsilane 9 (3.0 g, 9.07 mmol) in toluene (5 mL). After 1 mL of the amine was added, 1 drop of Karstedt's catalyst was added and then the mixture heated to 80° C. for a total of 8 h. An additional 1 mL of allylamine and 1 drop of Karstedt's catalyst was added at this time and the reaction allowed to proceed for a total of 24 h. Solvent was removed in vacuo (3 h, 80° C./1 mm Hg) to give 4.0 g (88%) product with 11% b-isomer. ¹H NMR (CDCl₃) d: 7.54 (m, 2H); 7.33 (m, 3H); 2.88 (dd, J=12.5, 4.7 Hz, 0.4H); 2.60 (t, J=7.0 Hz, 3.6H); 2.22 (m, 0.2H); 1.40 (m, 3.6H); 1.07 (m, 4H); 0.96 (d, J=7.4 Hz, 1.8H); 0.75 (m, 0.6H); 0.52 (m. 3.5H); 0.02-0.20 (m, 18H). ¹³C {¹H} NMR (CDCl₃): 133.79, 133.73, 129.63 (m), 45.41, 44.11, 27.56, 26.39, 15.12, 11.50, 0.11, −1.34 ppm.

### Compound D

To synthesize amino-siloxane D, a solution of allylamine (4.4 g, 77 mmol) in toluene (5 mL) was added dropwise to a solution of tetrakis(dimethylsiloxy)silane 15 (5.0 g, 15.2 mmol) with 1 drop of Karstedt's catalyst and heated to 85° C. After 24 h additional allylamine (1 g) and catalyst was added and the reaction allowed to continue for another 6 h. The solvent was removed in vacuo to give 7.0 g (82%) product with ˜18% b-isomer. ¹H NMR (CDCl₃) d: 4.85 (s, 2.6H); 2.90 (dd, J=12.5, 4.7 Hz, 0.2H); 2.63 (t, J=7.0 Hz, 1.8H); 2.56 (m, 0.2H); 1.54 (m, 2H); 1.06 (m, 0.6H); 0.86 (m, 0.2H); 0.61 (s, 2H); 0.15 (s, 10.6H). ¹³C {¹H} NMR (CDCl₃): 44.50 (m), 42.95, 26.34 (m), 25.49, 14.75, 10.44, −1.08, −2.54 ppm.

### Compound E

The amino-siloxane E was obtained from a private source.

### Compound F

To synthesize amino-siloxane F, 1,1,3,3,5,5,7,7-octamethyltetrasiloxane (5.65 g, 20 mmol) was dissolved in toluene (30 mL) and then 2 mL of allyl alcohol (2.8 g, 48 mmol) in toluene (10 mL) was added at ambient temperature followed by 1 drop of Karstedt's catalyst (4.3 wt % Pt in xylenes). The reaction mixture was heated to 40° C. and the remainder of the alcohol solution was added over 1 min. Heat was increased to reflux and the reaction allowed to continue for 18 h. After this time, the solution was concentrated in vacuo, dissolved in MeOH, filtered through Celite® and concentrated to give 5.6 g (67%) of bis(3-hydroxylpropyl)siloxane as a viscous brown liquid. ¹H NMR (CDCl₃) d: 3.83 (m, 1.2H); 3.64 (m, 4H); 2.15 (br, 1.8H); 1.8 (m, 1.6H); 1.62 (m, 4.1H); 0.7 (m, 1.5H); 0.55 (m, 4H); 0.07-0.14 (45H).

Bis(3-hydroxypropyl)siloxane (5.4 g, 13.5 mmol) was cooled to 3° C., then 1 drop of pyridine was added followed by thionyl chloride (16.1 g, 135 mmol) dropwise with ice-bath cooling. After addition was complete, the bath was removed and the mixture stirred at ambient temperature for 4 h the reflux for an additional 7 h. Excess thionyl chloride was removed by distillation and the residue dissolved in CH₂C₁₂, washed with water, then brine then dried over MgSO₄, concentrated and allowed to stand. After two days, the solid that had precipitated out was removed by filtration and bis(3-chloropropyl)siloxane as a clear orange liquid was obtained. (3.2 g, 54%). ¹H NMR (CDCl₃) d: 3.53 (t, J=7.1 Hz, 4H); 1.82 (m, 4H); 0.66 (m, 4H); 0.10 (s, 40H). ¹³C {¹H} NMR (CDCl₃): 47.84, 27.06, 15.90, 1.15, 0.74, 0.27, 0.11 ppm.

Bis(3-chloropropyl)siloxane (3.0 g, 4.8 mmol) was dissolved in acetone (20 mL) then NaI (4.1 g, 27.6 mmol) in acetone (40 mL) was added and the reaction mixture heated to reflux for 3 days. After this time, the reaction was concentrated, the residue dissolved in CHCl₃, washed with water (2×), aq Na₂SO₃, brine, dried over MgSO₄, and concentrated to give 3.26 g (84%) bis(3-iodopropropyl)siloxane as an orange oil. ¹H NMR (CDCl₃) d: 3.22 (m, 4H); 1.87 (m, 4H); 0.65 (m, 4H); 0.10 (s, 38H). ¹³C {¹H} NMR (CDCl₃): 28.23, 20.22, 11.12, 1.09, 0.37, 0.19 ppm.

Bis(3-iodopropyl)siloxane (2.7 g, 3.33 mmol) was added to ethoxyaminoethane (6.7 g, 75 mmol) at ambient temperature over 15 min and stirred at ambient temperature for 22. Excess amine was removed in vacuo and the residue dissolved in heptane, treated with 10% NaOH (aq) and the layers separated. The organic layer was washed with water and brine and dried over Na₂SO₄, filtered and concentrated to give 1.9 g (79%) compound F as a light orange oil. ¹H NMR (CDCl₃) d: 3.58 (m, 8H); 2.79 (t, J=5.4 Hz, 4H); 2.62 (t, J=7.4 Hz, 4H); 1.53 (m, 4H); 1.51 (br, 2H); 1.22 (t, J=7.1 Hz, 6H); 0.53 (m, 4H); 0.09-0.06 (ms, 38.8H). ¹³C {¹H} NMR (CDCl₃): 69.99, 66.41, 53.29, 49.53, 23.88, 23.83, 15.88, 15.73, 15.17, 1.17, 1.04, 0.29, 0.10 ppm.

### Compound G

To synthesize amino-siloxane G, Et₃N (16 mL, 115 mmol) was added to a solution of allylamine (32.93 g, 577 mmol) in THF (40 mL), heated to 60° C. and then 2-bromoethyl ethylether (17.65 g, 115 mmol) was added over 10 min. After 3 h excess solvent and allylamine were removed in vacuo, the residue dissolved in CHCl₃, washed with water, dried over Na₂SO₄, filtered, concentrated and distilled to give 11.2 g (75%) N-(2-ethoxyethyl)allylamine. ¹H NMR (CDCl₃) d: 5.88 (m, 1H); 5.15 (dm, J=17.2 Hz, 1H); 5.05 (dm, J=10.4 Hz, 1H); 3.51 (m, 4H); 3.24 (m, 1H); 3.23 (m, 1H); 2.75 (t, J=5.1 Hz, 2H); 1.57 (br, 1H); 1.18 (t, J=7.1 Hz, 3H). ¹³C {¹H} NMR (CDCl₃): 136.83, 115.78, 69.85, 66.38, 52.40, 48.81, 15.11 ppm.

N-(2-ethoxyethyl)-allylamine (2.0 g, 15.2 mmol) was added to hydride capped siloxane (5.0 g, 6.9 mmol, Gelest, DMS-H03) over 2 min with 1 drop of Karstedt's catalyst and heated to 80° C. for 18 h. Volatiles were removed in vacuo to give 5.66 g (83%) compound G with 40% b-isomer. ¹H NMR (CDCl₃) d: 3.54 (m, 11.5H); 2.76 (m, 6.4H); 2.62 (m, 3.5H); 2.51 (0.9H); 1.59 (m, 3.7H); 1.22 (m, 8.6H); 1.03 (m, 3.7H); 0.59 (m, 4H); 0.09-0.14 (m, 94H). ¹³C {¹H} NMR (CDCl₃): 68.74, 66.04, 52.35, 51.03, 48.42, 22.84, 21.75, 15.22, 14.22, 11.07, 0.18, −0.93, −2.56 ppm.

### Compound H

To synthesize amino-siloxane H, a solution of N-(2-ethoxyethyl)allylamine (2.6 g, 20 mmol) in toluene (5 mL) was added dropwise to a solution of tris(dimethylsiloxy)phenylsilane (2.0 g, 6 mmol) in toluene (5 mL). after 1 mL of the olefin had been added to the hydride followed by 1 drop of Karstedt's catalyst. The mixture was heated to 50° C. and then to 100° C. with an additional 1 drop of catalyst added. After 22 h, the reaction mixture was concentrated, dissolved in CHCl₃, washed with water, dried over Na₂SO₄, filtered, concentrated and volatiles removed at 100° C./1 mm Hg for 1 h to yield 4.3 g (99%) product as a clear orange liquid with ˜20% b-isomer. ¹H NMR (CDCl₃) d: 7.54 (m, 2H); 7.32 (m, 3H); 3.51 (m, 10.1H), 2.75 (m, 5.2H); 2.59 (m, 4.3H); 1.48 (m, 6.1H); 1.21 (m, 8.4H); 1.17 (m, 1.14H); 0.57 (m, 3.7H); 0.12 (m, 19.4H). ¹³C {¹H} NMR (CDCl₃): 133.81, 133.76, 129.54, 127.53, 127.49, 69.97, 66.38, 53.22, 51.50, 49.36, 49.24, 23.73, 22.44, 15.66, 15.61, 15.17, 12.02, 1.07, 0.10 ppm.

### Compound I

To synthesize amino-siloxane I, a solution of N-(2-ethoxyethyl)-allylamine (6.0 g, 46.4 mmol) in toluene (5 mL) was added dropwise to a solution of tetrakis(dimethylsiloxy)silane (3.0 g, 9.3 mmol) with 1 drop of Karstedt's catalyst and heated to 85° C. Two additional aliquots of olefin and catalyst added at 5 and 22 h. A small amount of hydride remained after 24 hours so 1-hexene (0.5 mL) was added to quench any remaining S—H groups. The solvent was removed in vacuo to give 6.1 g (78%) compound I with ˜25% b-isomer. ¹H NMR (CDCl₃) d: 3.48 (m, 16H); 2.75 (m, 8H); 2.56 (m, 7H); 1.51 (br m, 6H); 1.17 (t, J=6.8 Hz, 12H); 0.97 (m, 3H); 0.55 (m, 5.85H); 0.07 (s, 32H). ¹³C {¹H} NMR (CDCl₃): 69.91, 66.36, 55.23, 51.42, 23.67, 22.36, 15.53, 15.15, 11.91, 0.95, −0.12 ppm.

### Compound J

To synthesize amino-siloxane J, a solution of N-(2-ethoxyethyl)allylamine (5.4 g, 41.6 mmol) in toluene (2 mL) was added dropwise to a solution of 1,3,5,7-tetramethylcyclotetrasiloxane (3.0 g, 9.3 mmol) in toluene (3 mL) with 1 drop of Karstedt's catalyst and heated to 90° C. Two additional aliquots of olefin and catalyst added at 5 and 23 h. A small amount of hydride remained after 24 hours so 1-hexene (0.5 mL) was added to quench any remaining S—H groups. The solvent was removed in vacuo to give 5.25 g (83%) product with ˜50% b-isomer. ¹H NMR (CDCl₃) d: 3.50 (m, 7.9H); 2.75 (m, 4H); 2.70 (m, 1H); 2.59 (m, 2H); 2.47 (m, 1H); 1.67 (br, 1.8H); 1.52 (m, 2H); 1.19 (m, 6H); 0.97 (m, 3.3H); 0.51 (m, 2H); 0.07 (7.8H). ¹³C {¹H} NMR (CDCl₃): 69.92, 66.36, 53.01, 51.40, 49.36, 23.45, 21.77, 15.15, 14.56, 11.95, 0.75, −2.14 ppm.

### Compound K

To synthesize amino-siloxane K, allylamine (20.5 g, 360 mmol) and NEt₃ (13.9 mL, 100 mmol) were added together followed by slow addition (35 min) of 2-bromoethyl methylether (10.0 g, 72 mmol) while heating to 50° C. After 2 h the reaction was two phases. The upper phase was isolated and concentrated to an orange oil that was diluted with heptane and washed with 10% NaOH, water and then dried over Na₂SO₄. The aqueous base contained most of the product and the base wash was extracted with CHCl₃, concentrated and distilled (115-120° C./300 mm Hg) to give 1.9 g (23%)N-(2-methoxyethyl)allylamine. ¹H NMR (CDCl₃) d: 5.85 (m, 1H); 5.12 (dd, J=17.2, 1.5 Hz, 1H); 5.02 (dd, J=10.4, 1.5 Hz, 1H); 3.44 (t, J=5.2 Hz, 2H); 3.30 (s, 3H); 2.72 (t, J=5.2 Hz, 2H); 3.21 (dt, J=6.1, 1.4 Hz, 2H); 1.44 (br, 1H). ¹³C {¹H} NMR (CDCl₃): 136.76, 115.78, 71.99, 58.71, 52.35, 48.62 ppm.

The compound N-(2-methoxyethyl)-allylamine (1.5 g, 13 mmol) was added to hydride capped siloxane (4.3 g, 6 mmol, Gelest, DMS-H03) over 1 min with 1 drop of Karstedt's catalyst and heated to 50° C. for 1 h. Volatiles were removed in vacuo to give 5.1 g (89%) compound K with 55% b-isomer. ¹H NMR (CDCl₃) d: 3.48 (t, J=5.0 Hz, 4H); 3.34 (s, 6H); 2.73 (m, 5.1H); 2.59 (t J=6.8 Hz, 1.8H); 2.47 (m, 1.2H); 1.51 (m. 1.9H); 1.35 (br, 1.8H); 0.96 (m, 4.5H); 0.54 (m, 1.8H); 0.06 (m, 60.7H). ¹³C {¹H} NMR (CDCl₃): 72.17, 72.14, 58.74, 58.71, 49.28, 49.20, 23.78, 22.38, 15.69, 12.05, 1.12, 0.05, −1.39 ppm.

### Compound L

To synthesize amino-siloxane L, 2-hydroxyethyl ethyl thioether (9.0 g, 85 mmol) was dissolved in CH₂Cl₂ (100 mL), cooled to 0° C. and phosphorous tribromide (8.0 mL, 85 mmol) was added dropwise over 30 min. The reaction mixture remained at 0° C. for 2 h then the reaction was allowed to come to ambient temperature and stirred for 18 h. The mixture was again cooled to 0° C. and water (10 mL) was added followed by sat. Na₂CO₃ (˜60 mL) until pH=7. The layers were separated, dried over Na₂SO₄ and concentrated in vacuo to give 13.1 g (91%) 2-bromoethyl ethyl thioether as a colorless liquid. ¹H NMR (CDCl₃) d: 3.49 (t, J=7.7 Hz, 2H); 2.95 (t, J=8.2 Hz, 2H); 2.59 (q, J=7.3 Hz, 2H); 1.28 (t, J=7.3 Hz, 3H). ¹³C {¹H} NMR (CDCl₃): 33.71, 30.60, 26.16, 14.91 ppm. Allylamine (15 g, 260 mmol), K₂CO₃ (43 g, 310 mmol) and THF (70 mL) were added together followed by dropwise addition (5 min) of 2-bromoethyl ethyl thioether (7.3 g, 43 mmol) at ambient temperature. After 24 h, an additional allylamine (9.8 g) and THF (40 mL) were added and the temperature increased to 40° C. After 4 days, the mixture was filtered, concentrated in vacuo and distilled (160-163° C./255 m Hg) to give 4.8 g (77%)N-(2-ethylthioethyl)allylamine as a colorless liquid. ¹H NMR (CDCl₃) d: 5.86 (m, 1H); 5.12 (dm, J=17.2 Hz, 1H); 5.07 (dm, J=10.1 Hz, 1H); 3.24 (m, 2H); 2.77 (m, 2H); 2.66 (m, 2H); 2.50 (m, 2H); 1.59 (br, 1H); 1.23 (m, 3H). ¹³C {¹H} NMR (CDCl₃): 136.66, 115.95, 52.00, 47.82, 31.84, 25.73, 14.83 ppm.

The compound N-(2-ethylthioethyl)-allylamine (1.9 g, 13 mmol) was added to hydride capped siloxane (4.3 g, 6 mmol, Gelest, DMS-H03) with 1 drop of Karstedt's catalyst. After 15 min, 4 more drops of catalyst were added and heated to 80° C. for 18 h. Volatiles were removed in vacuo to give 5.2 g (85%) compound L with 55% b-isomer. ¹H NMR (CDCl₃) d: 2.76 (m, 2.4H); 2.69 (m, 2.2H); 2.60 (t, J=7.4 Hz, 0.9H); 2.53 (m, 2.6H); 1.6 (br, 1H); 1.51 (m, 0.9H); 1.25 (t, J=7.3 Hz, 3H); 0.97 (m, 2.1H); 0.52 (m, 0.9H), 0.02 (s, 30.8H). ¹³C {¹H} NMR (CDCl₃): 52.80, 51.39, 48.47, 48.44, 31.95, 31.93, 25.75, 23.77, 22.36, 15.67, 14.86, 12.08, 1.15, 1.01, 0.08, −1.34 ppm.

### Compound M

To synthesize amino-siloxane M, allylamine (3.9 g, 32 mmol) and NEt₃ (4.5 mL, 32 mmol) were added together followed by dropwise addition (5 min) of allylbromide (3.9 g, 32 mmol) while heating to 60° C. After 18 h the reaction was diluted with CHCl₃, washed with water, dried over Na₂SO₄ filtered and concentrated to give 1.0 g (24%)N-(2-dimethylaminoethyl)allylamine which was flash distilled at 80° C./100 mm Hg to remove color. ¹H NMR (CDCl₃) d: 5.91 (m, 1H); 5.17 (dd, J=17.2, 1.7 Hz, 1H); 5.08 (dd, J=10.1, 1.3 Hz, 1H); 3.27 (d, J=6.1 Hz, 2H); 2.68 (t, J=6.2 Hz, 2H); 2.41 (t, J=6.1, 2H); 2.22 (s, 6H); 1.66 (br, 1H). ¹³C {¹H} NMR (CDCl₃): 136.93, 115.81, 59.17, 52.56, 46.68, 45.56 ppm.

The compound N-(2-dimethylaminoethyl)-allylamine (0.74 g, 5.8 mmol) was added to hydride capped siloxane (1.96 g, 2.7 mmol, Gelest, DMS-H03) at 50° C. with 1 drop of Karstedt's catalyst. After 6 h, 2 more drops of catalyst were added and heated to 75° C. for 24 h. Volatiles were removed in vacuo to give 1.95 g (74%) compound M with 40% b-isomer. ¹H NMR (CDCl₃) d: 2.70 (m, 1.9H); 2.62 (m, 1.6H); 2.44 (m, 2.5H); 2.23 (s, 6H); 2.02 (br, 1H); 1.54 (m, 1.2H); 0.99 (m, 1.6H); 0.55 (m, 1.2H), 0.09 (s, 73.7H). ¹³C {¹H} NMR (CDCl₃): 59.21, 59.12, 53.40, 51.84, 47.27, 47.19, 45.58, 23.72, 22.21, 15.72, 12.08, 1.17, 1.03, 0.16 ppm. ²⁹Si NMR (CDCl₃+Cr(acac)₃): 8.11, 7.55, −21.53, −21.95, −22.10 ppm.

### Compound N

To synthesize the amino-siloxane N, 2-ethoxyethyl aminoethane (38.2 g, 429 mmol), K₂CO₃ (10.1 g, 73.2 mmol) and THF (50 mL) were heated to 60° C. then 5-bromo-1-pentene (10.02 g, 67.2 mmol) was added over 25 min and the reaction allowed to continue for 22 h. The reaction mixture was filtered, concentrated and distilled (130° C./130 mm Hg) to give 7.2 g (68%)N-(2-ethoxyethyl)aminopent-5-ene as a colorless liquid. ¹H NMR (CDCl₃) d: 5.81 (m, 1H); 5.01 (d, J=16.9 Hz, 1H); 4.93 (d, J=10.1 Hz, 1H); 3.52 (t, J=5.5 Hz, 2H); 3.49 (q, J=7.1 Hz, 2H); 2.76 (t, J=5.2 Hz, 2H); 2.62 (t, J=7.3 Hz, 2H); 2.08 (q, J=6.8 Hz, 2H); 1.60 (m, 2H); 1.46 (br, 1H); 1.19 (t, J=7.1 Hz, 3H). ¹³C {¹H} NMR (CDCl₃): 138.49, 114.53, 69.88, 66.39, 49.48, 49.45, 31.54, 29.27, 15.14 ppm.

A solution of N-(2-ethoxyethyl)aminopent-5-ene (5.0 g, 31.8 mmol) in toluene (10 mL) was added dropwise to 1,1,3,3,5,5-hexamethyltrisiloxane (3.32 g, 15.9 mmol) heated at 55° C. with 1 drop of Karstedt's catalyst. The temperature was raised to 65° C. after addition was complete and after 8 h the reaction mixture was concentrated in vacuo to give 7.95 g (91%) compound Ia (95% pure with ˜10% b-isomer) with ˜5% of unreacted olefinic amine isomers. ¹H NMR (CDCl₃) d: 3.52 (t, J=5.3 Hz, 4.5H); 3.48 (q, J=7.1 Hz, 4.5H); 2.76 (m, 4.4H); 2.59 (m, 4.4H); 2.08 (q, J=6.8 Hz, 2H); 1.58 (m, 0.3H); 1.48 (m, 4.4H); 1.33 (m, 11.1H); 1.18 (t, J=7.0 Hz, 6.7H); 0.91 (m, 0.7H); 0.52 (m, 4H); 0.05-0.01 (m, 21.7H). ¹³C {¹H} NMR (CDCl₃): 69.94, 66.37, 50.05, 49.55, 31.12, 29.91, 23.17, 18.22, 15.13, 1.25, 1.16, 0.16 ppm.

As used herein, a structure, composition, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein. Instead, the use of “configured to” as used herein denotes structural adaptations or characteristics, and denotes structural requirements of any structure, composition, or element that is described as being “configured to” perform the task or operation.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various embodiments, and also to enable a person having ordinary skill in the art to practice the various embodiments, including making and using any compositions or systems and performing any incorporated methods. The patentable scope of the various embodiments is defined by the claims, and may include other examples that occur to those skilled in the art. Such other examples are intended to be within the scope of the claims if the examples have structural elements that do not differ from the literal language of the claims, or the examples include equivalent structural elements with insubstantial differences from the literal language of the claims.

What is claimed is:

1. An absorbent composition comprising an amino-siloxane comprising structure (I): 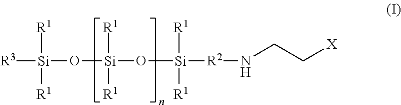
wherein R¹ is independently at each occurrence a C₁-C₆ aliphatic or aromatic radical; R² is independently at each occurrence a C₂-C₁₀ aliphatic or aromatic radical; and R³ is independently at each occurrence a C₁-C₁₈ aliphatic or aromatic radical or R⁴, wherein R⁴ comprises structure (II): 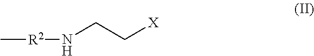
wherein X is independently at each occurrence an electron donating group; and n is at least 1.

2. The absorbent composition of claim 1, wherein X independently at each occurrence comprises an R⁵O— group, an R⁵S— group, an (R⁵)₂N— group, or an (R⁵)₂P— group, wherein R⁵ is independently at each occurrence a C₁-C₈ aliphatic or aromatic radical.

3. The absorbent composition of claim 1, wherein X at each occurrence comprises a C₂H₅O— group.

4. The absorbent composition of claim 1, wherein X independently at each occurrence comprises a CH₃O— group, a C₂H₅O— group, a (C₂H₅)₂N— group, a (C₂H₅)₂P— group, or a C₂H₅S— group.

5. The absorbent composition of claim 1, wherein R² is independently at each occurrence a C₃ aliphatic radical in a linear propyl form or a branched isopropyl form.

6. The absorbent composition of claim 1, wherein n is at least 3.

7. The absorbent composition of claim 1, wherein the absorbent composition is substantially free of a co-solvent with the amino-siloxane.

8. The absorbent composition of claim 1, wherein the amino-siloxane is configured to form a reaction product with carbon dioxide, the reaction product being substantially liquid at temperatures between about 20 degrees Celsius and about 70 degrees Celsius.

9. An absorbent composition comprising an amino-siloxane comprising structure (III): 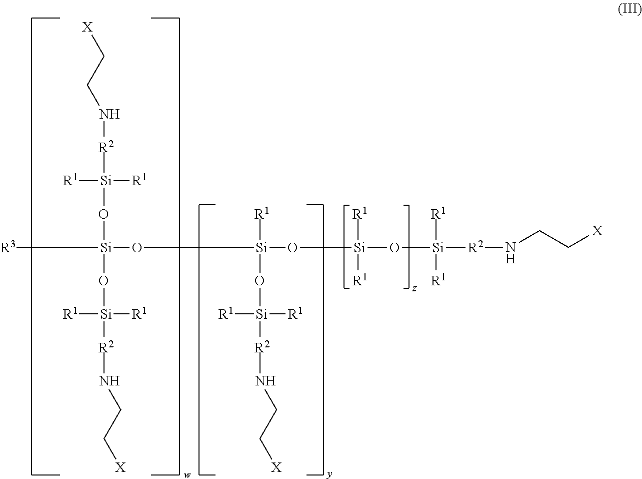
wherein R¹ is independently at each occurrence a C₁-C₆ aliphatic or aromatic radical; R² is independently at each occurrence a C₂-C₁₀ aliphatic or aromatic radical; and R³ is independently at each occurrence a C₁-C₁₈ aliphatic or aromatic radical or R⁴, wherein R⁴ comprises structure (IV): 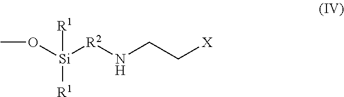
wherein X is independently at each occurrence an electron donating group; w is between 0 and 5; y is between 0 and 10; and z is between 0 and 10; wherein a sum of w, y, and z is at least 1.

10. The absorbent composition of claim 9, wherein R³ is the aromatic radical phenyl group.

11. The absorbent composition of claim 9, wherein R³ is the structure (IV) of R⁴ and w is at least 1, such that the amino-siloxane is tetra-functional.

12. The absorbent composition of claim 9, wherein X independently at each occurrence comprises an R⁵O— group, an R⁵S— group, an (R⁵)₂N— group, or an (R⁵)₂P— group, wherein R⁵ is independently at each occurrence a C₁-C₈ aliphatic or aromatic radical.

13. The absorbent composition of claim 9, wherein X independently at each occurrence comprises a CH₃O— group, a C₂H₅O— group, a (C₂H₅)₂N— group, a (C₂H₅)₂P— group, or a C₂H₅S— group.

14. The absorbent composition of claim 9, wherein R² is independently at each occurrence the C₃-C₅ aliphatic radical in a linear form or a branched form.

15. The absorbent composition of claim 9, wherein the absorbent composition is substantially free of a co-solvent with the amino-siloxane.

16. The absorbent composition of claim 9, wherein the amino-siloxane is configured to form a reaction product with carbon dioxide, the reaction product being substantially liquid at temperatures between about 20 degrees Celsius and about 70 degrees Celsius.

17. An absorbent composition comprising an amino-siloxane comprising structure (V): 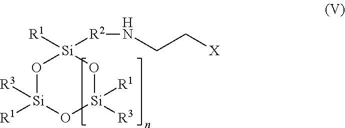
wherein R¹ is independently at each occurrence a C₁-C₆ aliphatic or aromatic radical; R² is independently at each occurrence a C₂-C₁₀ aliphatic or aromatic radical; and R³ is independently at each occurrence a C₁-Cis aliphatic or aromatic radical or R⁴, wherein R⁴ comprises structure (II): 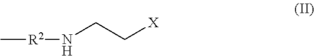
wherein X is independently at each occurrence an electron donating group; and n is between 1 and 6.

18. The absorbent composition of claim 17, wherein X independently at each occurrence comprises an R⁵O— group, an R⁵S— group, an (R⁵)₂N— group, or an (R⁵)₂P— group, wherein R⁵ is independently at each occurrence a C₁-C₈ aliphatic or aromatic radical.

19. The absorbent composition of claim 17, wherein the absorbent composition is substantially free of a co-solvent with the amino-siloxane.

20. The absorbent composition of claim 17, wherein the amino-siloxane is configured to form a reaction product with carbon dioxide, the reaction product being substantially liquid at temperatures between about 20 degrees Celsius and about 70 degrees Celsius.
